(19) United States
(12) Patent Application Publication
(10) Pub. No.: US 2008/0204432 A1
(43) Pub. Date: Aug. 28, 2008

(54) PORTABLE COMPUTER

(76) Inventors: Jung-Man Lim, Osan-si (KR); Seung-Bae Lee, Yongin-si (KR); Se-Il Kim, Seoul (KR)

Correspondence Address: F. CHAU & ASSOCIATES, LLC, 130 WOODBURY ROAD, WOODBURY, NY, 11797, US

(21) Appl. No.: 12/038,619

(22) Filed: Feb. 27, 2008

(30) Foreign Application Priority Data
Feb. 27, 2007 (KR) 10-2007-19819

(51) Int. Cl. G06F 3/038

(52) U.S. Cl. 345/204

(57) ABSTRACT

Disclosed is a portable computer with improved transception sensitivity to radio wave data. The portable computer includes an antenna for transceiving radio wave data. The antenna is disposed opposite to a display panel driver, a display region of the portable computer interposed therebetween.

### CROSS-REFERENCE TO RELATED APPLICATIONS

This U.S. non-provisional patent application claims priority under 35 U.S.C. §119 of Korean Patent Application No. 10-2007-19819 filed on Feb. 27, 2007, the entire contents of which are herein incorporated by reference.

### BACKGROUND OF THE INVENTION

1. Technical Field

The present invention disclosed herein relates to portable computers and more particularly, to a portable computer with improved transception (transmission and/or reception) sensitivity to radio wave data.

2. Discussion of Related Art

A portable computer typically includes a display panel for displaying images and a body for controlling data outputs corresponding to the images. The portable computer may perform transceiving (transmitting and/or receiving) and processing of radio wave data, the portable computer comprising an antenna for transmitting or receiving the radio wave data.

The antenna is connected to the body equipped for communication with a wireless wide area network (WWAN) or a wireless local area network (WLAN), and for transferring radio wave data to the body and transmitting data from the body.

Such a WLAN is able to transmit or receive radio wave data between pluralities of information processors that are not connected with each other through wires or cables.

Radio wave data is affected by electromagnetic interference (EMI) due to other kinds of electromagnetic waves generated around the antenna, by which a sensitivity of transceiving radio wave data of the portable computer would be degraded.

Therefore, a need exists for a portable computer with improved transception (transmission and/or reception) sensitivity to radio wave data.

### SUMMARY OF THE INVENTION

According to an embodiment of the present invention, a portable computer includes a display panel having a display region for displaying an image, an antenna disposed adjacent to the display panel, the antenna transceiving radio wave data, a data driver electrically connected to the display panel, providing image data to the display panel, the image data corresponding to the image, and a body combined with the display panel, controlling an operation of the data driver for the display of the image according to the radio wave data transceieved by the antenna, wherein the antenna and the data driver are disposed opposite to each other with the display region interposed therebetween and the data driver disposed adjacent to a portion where the display panel joins with the body.

The antenna is adjacent to the display panel.

As the antenna is placed at the location able to minimize interference between radio wave data and electromagnetic waves generated from the data driver, it improves transception sensitivity of the radio wave data in the portable computer.

Further understanding of embodiments of the present invention herein may be realized by reference to the remaining portions of the specification and the attached drawings.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified. In the figures:

FIG. 1 is a disassembled perspective view of a portable computer according to an embodiment of the present invention;

FIG. 2 is a back view showing a coupling condition among the LCD panel, the backlight unit, and the data driver shown in FIG. 1;

FIG. 3 is a side view showing a coupling condition among the LCD panel, the backlight unit, and the data driver shown in FIG. 1; and

FIG. 4 is a perspective view of the portable computer shown in FIG. 1.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to embodiments set forth herein. Rather, embodiments are provided so that this disclosure will be thorough and complete, and will fully convey the scope of the present invention to those skilled in the art. Like reference numerals refer to like elements throughout the accompanying figures.

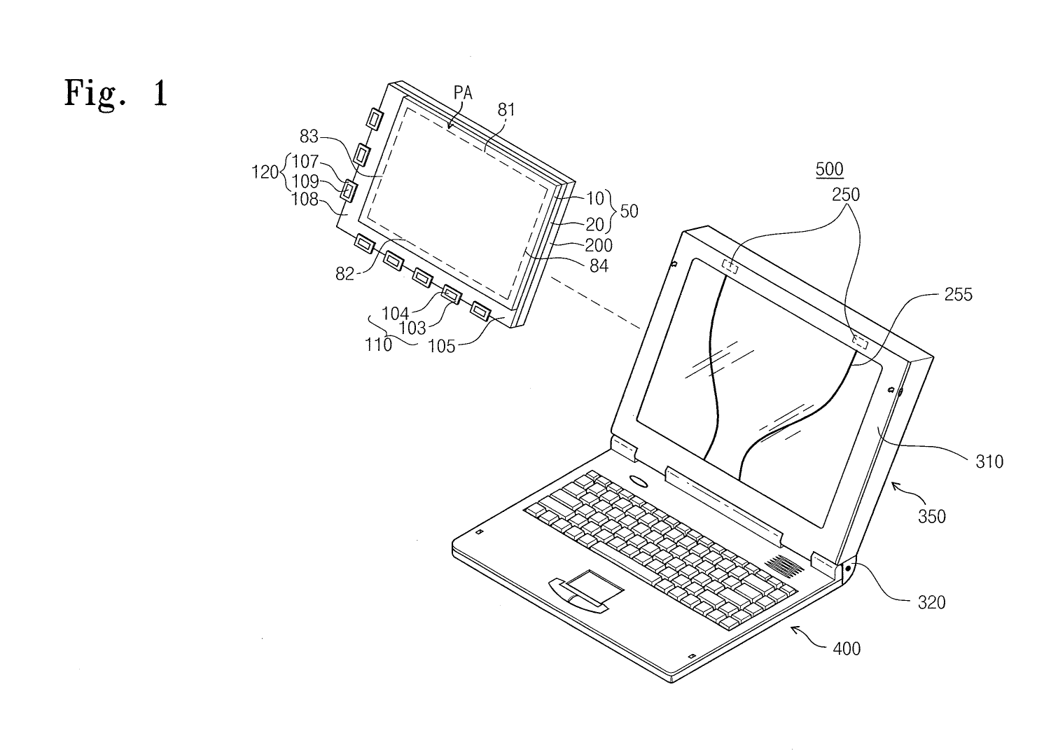

FIG. 1 is a disassembled perspective view of a portable computer 500 according to an embodiment of the present invention.

Referring to FIG. 1, the portable computer 500 is comprised of a liquid crystal display (LCD) panel 50, a backlight unit 200, a gate driver 120, a data driver 110, an antenna 250, a housing 350 accommodating the LCD panel 50 and the antenna 250, and a body 400.

In the LCD panel 50, a display region PA is defined as a component for displaying an image in the portable computer 500. An image may be displayed on the display region PA.

The LCD panel 50 includes a color filter substrate 10, a thin film transistor substrate 20, and liquid crystals (not shown) interposed between the color filter substrate 10 and the thin film transistor substrate 20.

The color filter substrate 10 is a transparent glass substrate having color layers (not shown) formed in the tetragon display region PA. Thus, light supplied from the backlight unit 200 is filtered to take on a desired color while passing through the color layers. On the color filter substrate 10, an indium tin oxide film of transparent conductor is formed as a common electrode (not shown).

The thin film transistor substrate 20 is a transparent glass substrate where thin film transistors are arranged in a matrix on the display region PA. On the display region PA, pixel electrodes (not shown) electrically connected to the thin film transistors are formed to generate electric fields with the common electrode. Additionally, at the end of the thin film transistor substrate 20, a data bonding pad 105 is coupled to the data driver 110 and the gate bonding pad 108 is coupled to the gate driver 120.

The backlight unit 200 supplies light into the LCD panel 50. The LCD panel 50 displays an image by means of the light supplied from the backlight unit 200. The backlight unit 200 has lamps (not shown) for radiating light.

The gate driver 120 is disposed at the gate bonding pad 108 adjacent to a first short side 83 of the display region PA. The gate driver 120 has a gate drive circuit film 107 contacting to the gate bonding pad 108, and a gate drive chip 109 bonded to the gate drive circuit film 107, generating gate signals to control switching operations of the thin film transistors of the LCD panel 50.

In an embodiment according to the present invention, the gate driver 120 is disposed in the LCD panel 50, being adjacent to the first short side 83. The gate driver 120 may be disposed adjacent to a second end side 84 opposite to a second short side 83.

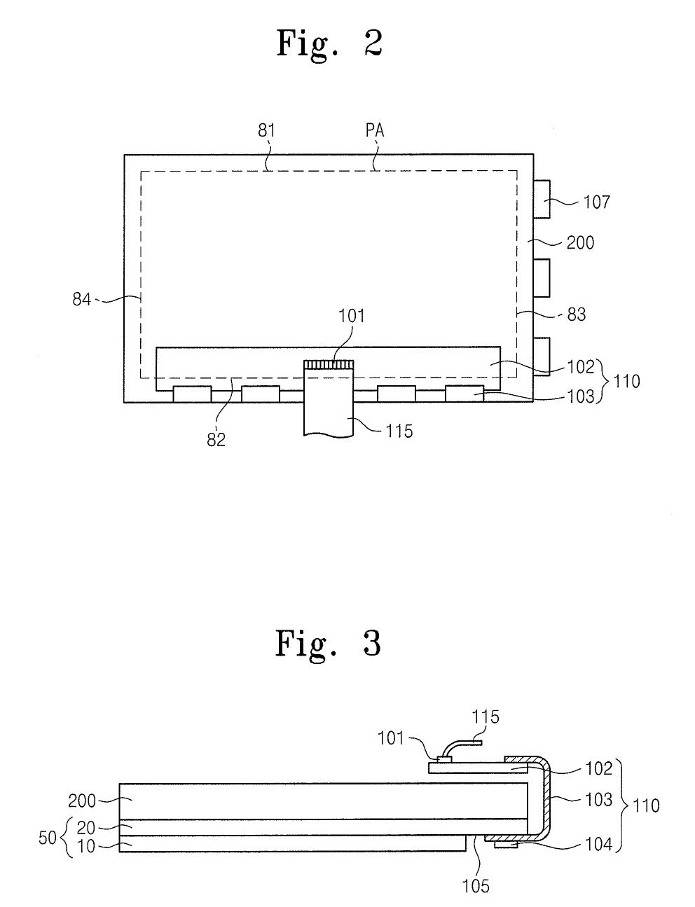

The data driver 110 is disposed on the data bonding pad 105 of the LCD panel 50, being adjacent to a first long side 82 of the display region PA. The data driver 110 is comprised of a data drive circuit film 103 contacting to the data bonding pad 105, a data drive chip 104 bonded to the data drive circuit film 103, and a source printed circuit board (source PCB) 102 (shown in FIG. 2) electrically connected to the data drive circuit film 103. The data drive circuit film 103 is flexible and the source PCB 102 is disposed opposite to the back of the backlight unit 200.

The data driver 110 operates to provide image data to the LCD panel 50 in correspondence with an image displayed by the LCD panel 50. While transferring the image data to the LCD panel 50 from the data driver 110, electromagnetic waves may be generated around the data driver 110.

The antenna 250 is disposed in the housing 350, receiving or transmitting radio wave data. The antenna 250 is connected to the body 400 by way of wires 255. The body 400 comprises the antenna 250 processing radio wave data transmitted or received via a WWAN or WLAN.

The antenna 250 is accommodated in the housing 350, being opposite to the data driver 110 with the display region PA interposed therebetween. When the LCD panel 50 combines with the housing 350, the antenna 250 locates adjacent to a second long side 81 opposite to the first long side 82 of the display region PA.

The housing 350 accommodates the LCD panel 50, the backlight unit 200, and the antenna 250, combining with the body 400 by hinge joints 320. At the front of the housing 350, a frame 310 is installed with a display window corresponding to the display region PA. In the housing 350, the antenna 250 is adjacent to the top of the frame 310.

The body 400 is electrically coupled to the LCD panel 50 by a flexible printed circuit (FPC) 115 (shown in FIG. 2). Additionally, the body 400 is electrically coupled to the antenna 250 by the wires 255.

As the body 400 includes many electronic elements, including ones for communicating via the WLAN and a main board including a central processing unit (CPU), electromagnetic waves are generated therefrom. Therefore, it is preferred for the antenna 250 not to be disposed in the body 400 in order to substantially prevent radio wave data, which is transceived by the antenna 250, from electromagnetically interfering with the electronic elements settled therein.

FIGS. 2 and 3 are back and side views showing a coupling condition of the LCD panel, the backlight unit, and the data driver shown in FIG. 1.

Referring to FIGS. 2 and 3, the data driver 110 is disposed at the end of the LCD panel 50, being adjacent to the first long side 82 of the display region PA. The data drive circuit film 103 of the data driver 110 is adhered to the data bonding pad 105, bending along sides of the thin film transistor substrate 20 and the backlight unit 200, and electrically connected to the source PCB 102 opposite to the back of the backlight unit 200.

Referring to FIG. 1 again, the first long side 82 of the display region PA, among the long sides of the display region PA, is adjacent to the hinge joints 320 that joins the body 400 with the housing 350.

The source PCB 102 is comprised of a connector 101. The connector 101 is coupled to the FPC 115 connected to the body 400. The FPC 115 functions to transfer image data, which are displayed on the LCD panel, between the body 400 and the data driver 110.

Extending toward the body 400 from the source PCB 102, the FPC 115 is isolated from the antenna 250 along a distance of the short side of the display region PA.

Having the data driver 110 disposed adjacent to the first long side 82 of the display region PA of the LCD panel 50 isolates the antenna 250 from the FPC 115 as well as the data driver 110.

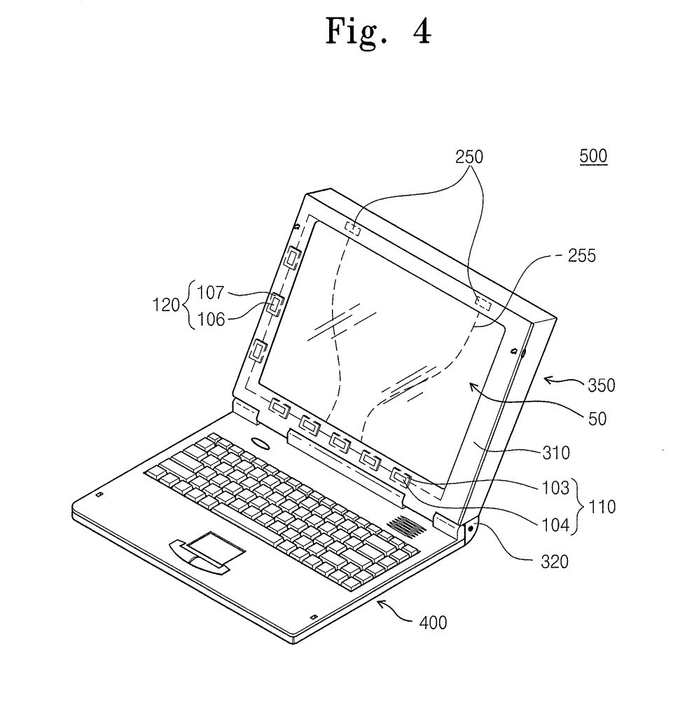

FIG. 4 is a perspective view of the portable computer shown in FIG. 1.

Referring to the FIG. 4, the wires 255 connecting the antenna 250 to the body 400 lay along the back of the LCD panel 50. The data driver 110 and the gate driver 120 are accommodated in the housing 350, overlapping with the frame 310 of the housing 350.

The data driver 110 is disposed at the bottom of the LCD panel 50, being adjacent to the hinge joints 320. The antenna 250 is accommodated in the housing 350, being adjacent to the top of the LCD panel 50. Thus, the data driver 110 is isolated from the antenna 250 along the distance of the short side of the LCD panel 50, to achieve low interference between radio wave data, which are transmitted or received by the antenna, and electromagnetic waves generated from the data driver 110.

As described above, in the portable computer according to an embodiment of the present invention, the data driver of the display panel is disposed opposite to the antenna, interposing the display region of the panel therebetween. The low interference between radio wave data, which are transmitted or received by the antenna, and electromagnetic waves generated from the data driver, improves the transception sensitivity of the antenna.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A portable computer comprising:
a display panel having a display region for displaying an image;
an antenna disposed adjacent to the display panel, the antenna transceiving radio wave data;
a data driver electrically connected to the display panel, providing image data to the display panel corresponding to the image; and
a body combined with the display panel, controlling an operation of the data driver for the display of the image according to the radio wave data transceived by the antenna,
wherein the antenna and the data driver are disposed opposite to each other with the display region interposed therebetween and the data driver disposed adjacent to a portion where the display panel joins with the body.

2. The portable computer as set forth in claim 1, wherein the data driver comprises:
a drive circuit film electrically connected to the display panel; and
a printed circuit board electrically connected to the drive circuit film and the body.

3. The portable computer as set forth in claim 2, wherein the display region is shaped in a tetragon.

4. The portable computer as set forth in claim 3, wherein the drive circuit film and the printed circuit board are disposed at an end of the display panel, adjacent to a first long side of the display region, and the first long side among long sides of the display region is adjacent to the portion where the display panel joins with the body.

5. The portable computer as set forth in claim 4, further comprising:
a housing accommodating the display panel and the antenna; and
a hinge connecting the housing and the body,
wherein the antenna is disposed in the housing, being adjacent to a second long side of the display region opposite to the first long side of the display region.

6. The portable computer as set forth in claim 3, further comprising:
a gate driver disposed at an end of the display panel parallel to a short side of the display region, providing a gate signal to the display panel.
